(19) United States
(12) Patent Application Publication
(10) Pub. No.: US 2013/0110347 A1
(43) Pub. Date: May 2, 2013

(54) DIRECTION INDICATOR CONTROL SYSTEM FOR VEHICLE AND METHOD FOR CONTROLLING DIRECTION INDICATOR LAMP

(71) Applicant: CHI-SHENG GE, Tu-Cheng (TW)

(72) Inventor: CHI-SHENG GE, Tu-Cheng (TW)

(73) Assignee: HON HAI PRECISION INDUSTRY CO., LTD., Tu-Cheng (TW)

(21) Appl. No.: 13/517,544

(22) Filed: Jun. 13, 2012

(30) Foreign Application Priority Data
Oct. 28, 2011 (TW) 100139245

(51) Int. Cl. G06F 7/00

(52) U.S. Cl. 701/36

(57) ABSTRACT

A direction indicator control system for a vehicle comprising a direction indicator lamp includes a global positioning system (GPS) navigation device, a receiver, and a controller. The GPS navigation device detects a speed of the vehicle and outputs speed information data indicating the speed of the vehicle to the vehicle to the receiver. The controller adjusts a flash frequency of a direction indicator lamp according to the speed information data received by the receiver.

### BACKGROUND

1. Technical Field

The present disclosure relates to automotive electronic technology, and more particularly, to a direction indicator control system for a vehicle, and a method for controlling a direction indicator lamp in a vehicle.

2. Description of Related Art

When a driver drives a car to a destination, he may have to make a number left or right turns. During the turning process, the driver needs to slow down according to a speed of a car in front of the driver. However, some inexperienced drivers may misjudge the speed of the car in front. A car crash may easily happen.

What is needed is to provide a means that can overcome the above-described limitations.

### BRIEF DESCRIPTION OF THE DRAWINGS

The components in the drawings are not necessarily drawn to scale, the emphasis instead placed upon clearly illustrating the principles of at least one embodiment. In the drawings, like reference numerals designate corresponding parts throughout the various views, and all the views are schematic.

FIG. 1 is a block diagram of a direction indicator control system for a vehicle according to an embodiment of the present disclosure.

FIG. 2 is a flowchart of a method for controlling a direction indicator lamp according to an embodiment of the present disclosure.

### DETAILED DESCRIPTION

Reference will now be made to the drawings to describe certain exemplary embodiments of the present disclosure in detail.

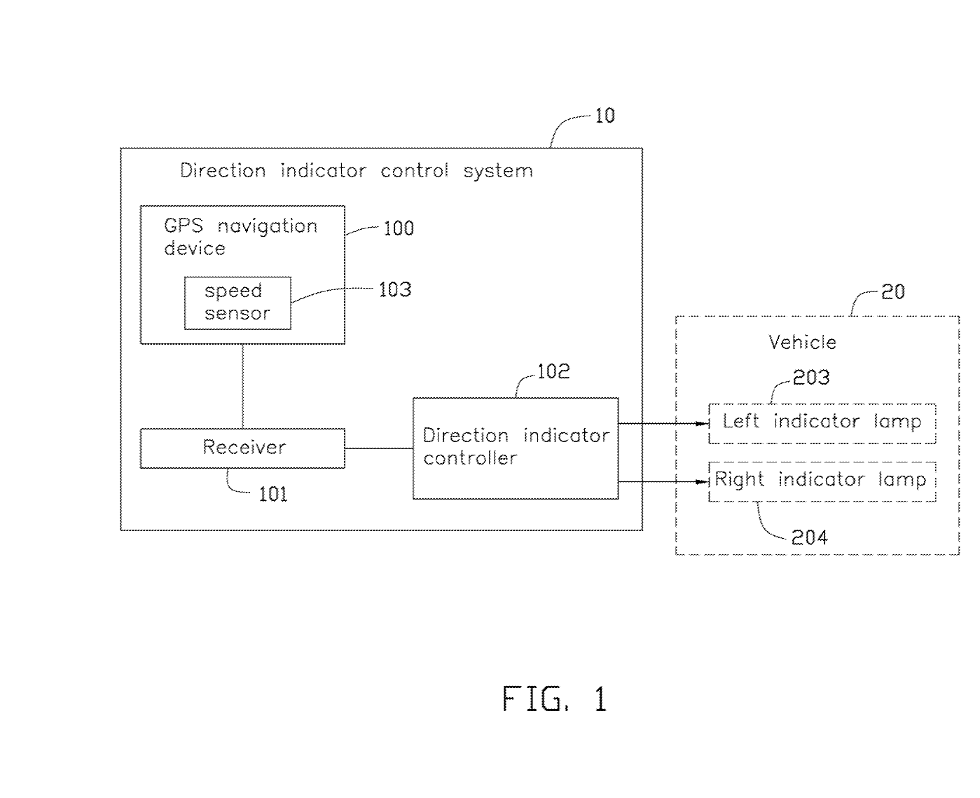

FIG. 1 is a block diagram of a direction indicator control system 10 for a vehicle according to an embodiment of the present disclosure. The direction indicator control system 10 for a vehicle 20 includes a Global Positioning System (GPS) navigation device 100, a receiver 101, and a direction indicator controller 102. The vehicle 20 includes a left indicator lamp 203, and a right indicator lamp 204. The receiver 101 can be a wireless receiver. The direction indicator controller 102 can be a microcontroller which is integrated as an internal module of the vehicle 20.

The GPS navigation device 100 displays an electronic map in a readable format such as a graphical format on a display of the GPS navigation device 100, provides a suggested route to a desired destination for a driver in control of the vehicle 20, and guides the driver to drive the vehicle 20 to the desired destination along the suggested route. The GPS navigation device 100 may be a stand-alone device independent of the vehicle 20, such as a mobile phone with GPS capability or a handheld personal navigation assistant. Alternatively, the GPS navigation device 100 may be integrated as an internal module of the vehicle 20.

The GPS navigation device 100 receives GPS signals for the purpose of determining a current location of the vehicle 20 during movement of the vehicle 20, and the GPS navigation device 100 matches the current location of the vehicle 20 with the suggested route to predict a next movement orientation of the vehicle 20.

When the GPS navigation device 100 finds the vehicle 20 is about to turn left or turn right, for example, when the GPS navigation device 100 finds a distance between the current location of the vehicle 20 and a next corner of a street that the vehicle 20 is about to pass in the suggested route is less than a first preset distance, the GPS navigation device 100 outputs a first indicator control signal to a receiver 101. The receiver 101 receives the first indicator control signal and provides the first indicator control signal to the direction indicator controller 102. The direction indicator controller 102 determines whether the vehicle 20 is about to turn left or turn right based on the first indicator control signal. Upon determining that the first indicator control signal indicates the vehicle 20 is about to turn left, the direction indicator controller 102 controls the left indictor lamp 203 to blink; and upon determining that the first indicator control signal indicates the vehicle 20 is about to turn right, the direction indicator controller 102 controls the right indicator lamp 204 to blink.

When the GPS navigation device 100 finds the vehicle 20 has finished the left turning or right turning, for example, when the GPS navigation device 100 finds a distance between the current location of the vehicle 20 and a previous corner of a street that the vehicle 20 has already passed in the suggested route is greater than a second preset distance, the GPS navigation device 100 outputs a second indicator control signal to the receiver 101. The receiver 101 receives the second indicator control signal and provides the second indicator control signal to the direction indicator controller 102. The direction indicator controller 102 also determines whether the vehicle 20 has finished the left or right turn based on the second indicator control signal. Upon determining that the second indicator control signal indicates the vehicle 20 has finished the left or right turn, the direction indicator controller 102 controls the left indicator lamp 203 or the right indicator lamp 204 to be turned off.

Moreover, in the present embodiment, the GPS navigation device 100 includes a speed sensor 103 that detects a current speed of the vehicle 20 and generates speed information data that comprises the current speed of the vehicle 20 and other relevant data of the vehicle 20. The speed information data is output to the vehicle 20 to adjust a flash frequency of the direction indicator lamp. In other embodiments, the speed sensor 103 may be integrated with the vehicle 20 and electronically linked with a speedometer of the vehicle 20.

Furthermore, the receiver 101 also receives the speed information data from the speed sensor 103, and the direction indicator controller 102 analyzes the speed information data determines whether the current speed of the vehicle 20 reaches a predetermined speed threshold. If the current speed of the vehicle 20 is greater than the predetermined speed threshold, the direction indicator controller 102 further controls the left indicator lamp 203 or the right indicator lamp 204 to increase the flash frequency thereof, such that a driver in a subsequent vehicle (either behind or adjacent to the vehicle 20) can be aware of the speed of the vehicle 20 and slow down to avoid a potential vehicle crash. If the current speed of the vehicle 20 is equal to or less than the predetermined speed threshold, the indicator controller 202 further controls the left indicator lamp 203 or the right indicator lamp 204 to reduce the flash frequency thereof.

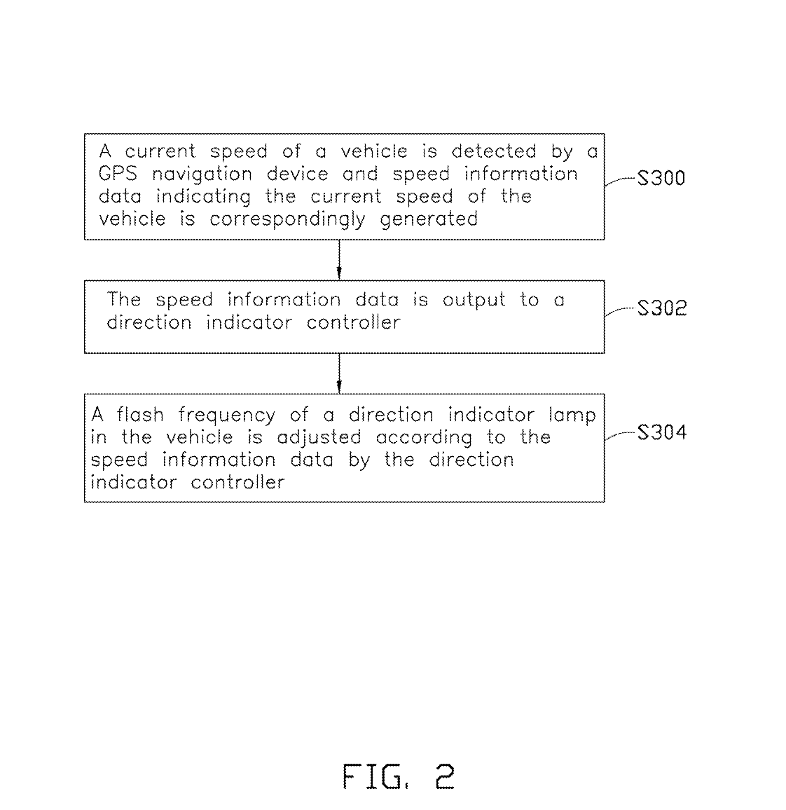

Based on the above-described direction indicator control system, the present disclosure further provides a method for controlling a direction indicator lamp in a vehicle. The method may be implemented in the vehicle, referring to FIG. 2, the method may include the following steps: step S300, a current speed of a vehicle 20 is detected by a GPS navigation device 100 and speed information data indicating the current speed of the vehicle 20 is correspondingly generated; step S302, the speed information data is output to a direction indicator controller 102; and step S304, a flash frequency of a direction indicator lamp in the vehicle 20 is adjusted according to the speed information data by the direction indicator controller 102.

In step S304, the direction indicator controller 102 increases the flash frequency of the direction indicator lamp when the speed information data indicates that the speed of the vehicle 20 is greater than a predetermined speed threshold; and the vehicle 20 reduces the flash frequency of the direction indicator lamp when the speed information data indicates that the speed of the vehicle 20 is equal to or less than the predetermined speed threshold.

In this embodiment, step S304 can be as follows: a receiver 101 receives the speed information data from the GPS navigation device 100 and provides the speed information data to the direction indicator controller 102, and the direction indicator controller 102 analyzes the speed information data received by the receiver 101. When the direction indicator controller 102 finds the speed information data, indicates the current speed of the vehicle 20 is greater than a predetermined speed threshold, then, the direction indicator controller 102 controls the left indicator lamp or the right indicator lamp 203 to increase the flash frequency; and when the direction indicator controller 102 finds the speed information data indicates the speed of the vehicle 20 is equal to or less than the predetermined speed threshold, the direction indicator controller 102 controls the left indicator lamp or the right indicator lamp 203 to reduce the flash frequency.

In one embodiment, the method may further include the following steps: the GPS navigation device 100 detects a current location of the vehicle 20 and then predicts a next movement orientation of the vehicle 20. When the GPS navigation device 100 finds a distance between the current location of the vehicle 20 and a next corner that the vehicle 20 is about to pass is less than a first preset distance, the GPS navigation device 100 outputs a first indictor control signal to the receiver 101; and the direction indicator controller 102 turns on the direction indication lamp upon receiving the first indicator control signal from the GPS navigation device 100.

When the GPS navigation device 100 finds a distance between the current location of the vehicle 20 and a previous corner that the vehicle 20 has already passed is greater than a second preset distance, the GPS navigation device 100 outputs a second indictor control signal to the receiver 101, and the direction indicator controller 102 turns off the direction indication lamp upon receiving the first indicator control signal from the GPS navigation device 100.

In this embodiment, the first indicator control signal can also indicate whether the vehicle 20 is about to turn left or turn right, and the direction indicator controller 102 receives the first indictor control signal from the GPS navigation device 100 by use of the receiver 101, and when the first indicator control signal indicates that the vehicle 20 is about to turn left, the direction indicator controller 102 controls the left indicator lamp 203 to flash by using the direction indicator controller 102 and when the first indicator control signal indicates that the vehicle 20 is about to turn left, the direction indicator controller 102 controls the right indicator lamp 204 to flash by using the direction indicator controller 102.

It is to be further understood that even though numerous characteristics and advantages of preferred and exemplary embodiments have been set out in the foregoing description, together with details of the structures and functions of the embodiments, the disclosure is illustrative only; and that changes may be made in detail, especially in matters of shape, size and arrangement of parts within the principles of the present disclosure to the full extent indicated by the broad general meaning of the terms in which the appended claims are expressed.

What is claimed is:

1. A direction indicator control system for a vehicle comprising a direction indicator lamp, comprising:
a global positioning system (GPS) navigation device configured for detecting a speed of the vehicle and outputting corresponding speed information data;
a receiver that receives the speed information data from the GPS navigation device; and
a controller that adjusts a flash frequency of the direction indicator lamp according to the speed information data from the receiver.

2. The direction indicator control system of claim 1, wherein the controller increases the flash frequency of the direction indicator lamp in response to the speed information data indicating that the speed of the vehicle is greater than a predetermined speed threshold, and reduces the flash frequency of the direction indicator lamp in response to the speed information data indicating that the speed of the vehicle is equal to or less than the predetermined speed threshold.

3. The direction indicator control system of claim 1, wherein the GPS navigation device is further configured for outputting a first indicator control signal to the receiver when the GPS navigation device determines that a distance between a current location of the vehicle and a next corner of a street that the vehicle is about to pass is less than a first preset distance, wherein the first indicator control signal is configured for controlling the controller to turn on the direction indication lamp.

4. The direction indicator control system of claim 3, wherein the GPS navigation device is further configured for outputting a second indicator control signal to the receiver when the GPS navigation device determines that a distance between the current location of the vehicle and a previous corner of a street that the vehicle has already passed is greater than a second preset distance, the second indicator control signal is configured for controlling the controller to turn off the direction indication lamp.

5. The direction indicator control system of claim 4, wherein the first indicator control signal indicates whether the vehicle indicates to turn left or turn right.

6. The direction indicator control system of claim 4, wherein the direction indicator controller is also configured for controlling the left indicator lamp or the right indicator lamp to increase the flash frequency of the left or right indicator lamps in response to the speed information data indicating the speed of the vehicle is greater than a predetermined speed threshold and controlling the left indicator lamp or the right indicator lamp to reduce the flash frequency of the left or right indicator lamps in response to the speed information data indicating the speed of the vehicle is equal to or less than the predetermined speed threshold.

7. The direction indicator control system of claim 1, wherein the controller is an integrated microcontroller of the vehicle.

8. A method for controlling a direction indicator lamp in a vehicle, comprising:
detecting, by a detector, a speed of a vehicle, and generating speed information data indicating the speed of the vehicle;
outputting, by the detector, the speed information data to a direction indicator controller; and
adjusting, by the direction indicator controller, a flash frequency of a direction indicator lamp of the vehicle according to the speed information data.

9. The method of claim 8, wherein the detector is a global positioning system (GPS) navigation device comprising a speed sensor.

10. The method of claim 9, wherein the adjusting a flash frequency of a direction indicator lamp of the vehicle according to the speed information data comprises:
increasing the flash frequency of the direction indicator lamp when the speed information data indicates that the speed of the vehicle is greater than a predetermined speed threshold; and
reducing the flash frequency of the direction indicator lamp when the speed information data indicates that the speed of the vehicle is equal to or less than the predetermined speed threshold.

11. The method of claim 9, wherein the outputting the speed information data to a direction indicator controller comprises:
receiving, by a receiver, speed information data from the GPS navigation device; and
providing the speed information data to the direction indicator controller.

12. The method of claim 11, further comprising:
determining, by the GPS navigation device, a current location of the vehicle;
outputting, by the GPS navigation device, a first indictor control signal to the direction indicator controller via the receiver when finding a distance between the current location of the vehicle and a next corner that the vehicle is about to pass is less than a first preset distance; and
turning on, by the direction indicator controller, the direction indication lamp upon receiving the first indicator control signal from the GPS navigation device.

13. The method of claim 12, further comprising:
outputting, by the GPS navigation device, a second indictor control signal to the direction indicator controller via the receiver when finding a distance between the current location of the vehicle and a previous corner that the vehicle has already passed is greater than a second preset distance; and
turning off, by the direction indicator controller, the direction indication lamp upon receiving the second indicator control signal from the GPS navigation device.

14. The method of claim 13, wherein the first indicator control signal indicates whether the vehicle indicates to turn left or turn right.

15. The method of claim 14, the adjusting a flash frequency of a direction indicator lamp in the vehicle according to the speed information data comprises:
receiving, by the receiver, the speed information data from the GPS navigation device;
controlling, by the direction indicator controller, the left indicator lamp or the right indicator lamp to increase the flash frequency when the speed information data indicates the speed of the vehicle is greater than a predetermined speed threshold; and
controlling, by the direction indicator controller, the left indicator lamp or the right indicator lamp to reduce the flash frequency when the speed information data indicates the speed of the vehicle is equal to or less than the predetermined speed threshold.

16. The method of claim 8, wherein the receiver is a wireless receiver.
